(19) United States
(12) Patent Application Publication
(10) Pub. No.: US 2020/0385253 A1
(43) Pub. Date: Dec. 10, 2020

(54) LIFTING DEVICE FOR A LIFTING CARRIAGE

(71) Applicant: Dematic GmbH, Heusenstamm (DE)

(72) Inventors: Michael Maurer, Hainburg (DE); Helmut Rositzka, Essen (DE); Adi Ceric, Obertshausen (DE); Jens Hußfeldt, Bad Homburg (DE)

(21) Appl. No.: 16/890,443

(22) Filed: Jun. 2, 2020

(30) Foreign Application Priority Data
Jun. 4, 2019 (DE) 102019115025.6

(51) Int. Cl. B66F 9/07; B66F 9/20

(52) U.S. Cl. CPC B66F 9/07; B66F 9/205

(57) ABSTRACT

A Lifting device for a lifting carriage, such as for a rack serving apparatus, having a drive mechanism comprising a motor drive, a winding drum driven by the motor drive, and a belt that is unwound from and wound onto the winding drum and serves to lift and lower the lifting carriage along a mast, where the belt may advantageously be configured as a flat belt. A control roller is arranged between the winding drum and the lifting carriage such that an angle of wrap greater than 20 degrees of the belt around the control roller is achieved.

### RELATED APPLICATION

The present application claims priority from German Patent Application No. 10 2019 115 025.6, filed Jun. 4, 2019.

### BACKGROUND AND FIELD OF THE INVENTION

The invention relates to a lifting device for a lifting carriage, in particular a rack serving apparatus, having a drive mechanism comprising a motor drive, a winding drum driven by the motor drive, and a belt, in particular a flat belt, which is unwound from and wound onto the winding drum and serves to lift and lower the lifting carriage along a mast. Lifting carriages or lifting trucks, e.g. of rack serving apparatuses, typically use steel cables or, more recently, belts as traction means for the vertical lifting movement.

For instance, EP 2 565 148 A1 discloses a rack serving apparatus comprising an at least substantially vertical frame, a lifting carriage which can be moved along this frame and a drive device for moving the lifting carriage, wherein the drive device has a motor, a traction means which can be driven by the motor, at least one deflection wheel, which is arranged in a rotatable manner on the lifting carriage, cooperates with the traction means and can be moved by the traction means, and at least one deflection roller which is arranged on the frame, wherein the deflection wheel, the deflection roller and the traction means form a pulley block, wherein acceleration forces of the motor both in the lifting direction and in the lowering direction can be transmitted actively to the lifting carriage by means of the traction means via the at least one deflection wheel. In this case, the traction means is preferably a toothed belt.

DE 197 20 861 C2 discloses vertically movable lifting carriages or other devices which can be moved via wheels or rollers and which, in the case of larger distances between axles, are driven mostly via traction means, such as e.g. cables, chains, toothed belts, etc.

Although the use of toothed belts and belts is preferred in terms of service life, maintenance and costs, it gives rise to technical requirements which can cause problems. For instance, it is complex to wind the belts if this is to be performed in a layered arrangement on the winding drum with parallel edges.

### SUMMARY OF THE INVENTION

The present invention provides an option by which belts, in particular flat belts, can be used as traction means or drives for the vertical lifting movement of lifting carriages or lifting carriages and can be wound onto and unwound from the winding drum with parallel edges. Various advantageous embodiments are disclosed in the claims and description.

In accordance with an aspect of the invention, if the lifting device for a lifting carriage is configured having a drive mechanism comprising a motor drive, a winding drum driven by the motor drive, and a belt which is unwound from and wound onto the winding drum and serves to lift and lower the lifting carriage along a mast, by arranging a control roller between the winding drum and the lifting carriage such that an angle of wrap greater than 20 degrees of the belt around the control roller is achieved, it becomes possible to achieve a symmetrical run-in and run-out of the belt onto the winding drum.

The control roller may be located in the entry and exit area of the winding drum and ensures the desired unwinding or winding (layering) of the belt on the winding drum. The angle of wrap is considered to be the contact region in angular degrees, in which the belt surrounds the control roller. To this end, the control roller can be arranged on the mast below or above the winding drum.

In a particular embodiment the run-in and run-out or layered arrangement is achieved if the control roller is additionally crowned (convex) or the control roller has a crowned surface. The crowning of the control roller may be in the range between 0 and 10 mm.

In order to further smooth the run of the belt, provision can be made that at least one bracket is arranged on the mast between the control roller and the lifting carriage or diverter pulley at the mast head, in which the belt runs in a guided manner. In the case of tall mast heights, it may then be expedient if brackets are arranged at least every 5 meters along the mast, in particular if the total mast height is greater than 20 meters. In addition, the brackets serve to stabilise the flat belt in the Z-direction and X-direction, as a result of which the lifting carriage can be positioned more precisely and more rapidly in front of the rack. The bracket is understood to be two rollers which arranged in parallel and can be rotated transversely to the running direction of the belt and between which the belt runs in a guided manner.

The belt can run via a plurality of deflectors between the control roller and the lifting carriage, e.g. for utilising the pulley block principle or constrictions in different transmissions (preferably 2:1, 3:1, etc.), whereby the drum forces are reduced and so very slender flat belts and small deflection geometries (rollers and connections) can be achieved. Moreover, smaller, more cost-effective transmissions can be used. A further advantage resides in the reduction in the approach dimensions. The deflectors can be fastened both to the mast head and the lifting carriage.

Fixed points or connection points of the belt can be arranged on the lifting carriage or on the mast head or mast cross beam depending upon the transmission ratio.

In particularly advantageous embodiments the belt is a flat belt. The use of the flat belt drive in different transmission ratios increases the service life of the drive means considerably. In comparison with a conventional cable drive, an increase in service life by a factor of 10 is realistic. Moreover, the flat belt is to be considered as virtually maintenance-free (no lubricating or greasing in comparison with cables, chains, etc.).

A further advantage is a reduction in the costs in comparison with cable drives or chain drives. In the case of the two-strand design (2 redundant flat belts), the differences in diameter, which occur by reason of differences in thickness, during winding on the winding drum are compensated for by a compensation roller at the fixed point.

The invention can likewise be transferred to two-mast or multiple-mast systems. A use in a rack serving apparatus, pallet lifter or lifting AGV is particularly preferred.

The invention achieves a multiplication in the service life (>10 years) and thus an indirect cost reduction as a result of lower expenditure on personnel, less maintenance, a reduction in costs (smaller drives, deflectors by reason of the transmission), optimisation of the approach dimensions, noise reduction, low-vibration running behaviour, more rapid and more precise positioning in front of the rack. The belt is protected from environmental influences by means of a synthetic material sheathing.

Further details of the invention will become clear from the following description of exemplified embodiments by reference to the drawings.

### BRIEF DESCRIPTION OF THE DRAWINGS

FIG. 1 is a schematic side view of a rack serving apparatus comprising a control roller above the winding drum on the mast; and

FIG. 2 is a schematic side view of a rack serving apparatus comprising a control roller below the winding drum on the mast.

### DESCRIPTION OF THE PREFERRED EMBODIMENTS

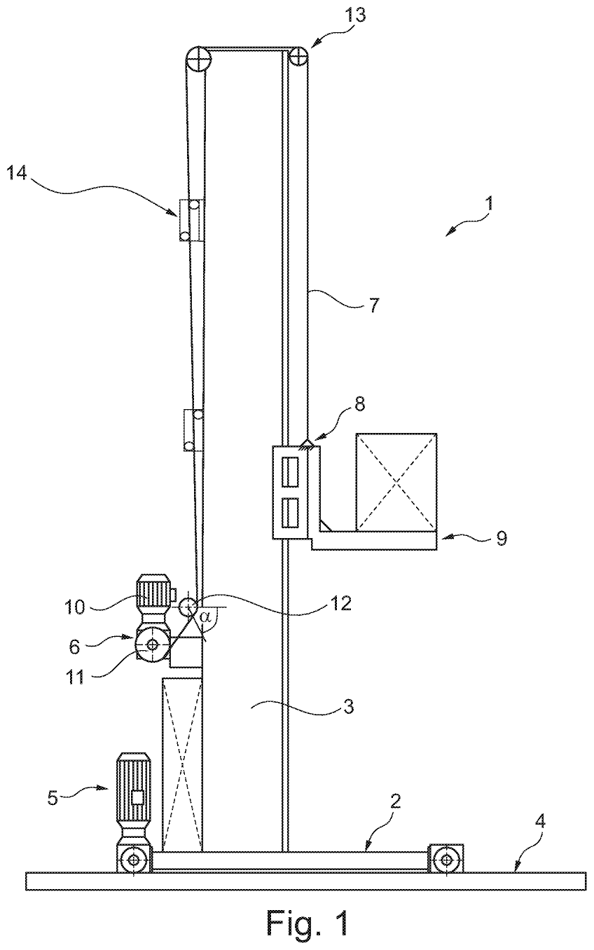

FIG. 1 illustrates a rack serving apparatus which is designated in its entirety by the reference numeral 1 and has a chassis 2 and a lifting mast 3. The chassis 2 can be moved horizontally on a rail 4 via a drive 5. On the lifting mast 3, a lifting carriage 9 can be lifted and lowered via a flat belt 7, for which reason the flat belt 7 is fixed to the lifting carriage 9 at a connection point 8.

For the purpose of lifting and lowering, the rack serving apparatus 1 has a lifting device 6 for the lifting carriage 9, which comprises a motor drive 10, a winding drum 11, which is driven by the motor drive 10, for the belt 7 which is unwound from and wound onto the winding drum 11, and a control roller 12 between the winding drum 11 and the lifting carriage 9 or deflector 13 on the mast head such that an angle of wrap α of the belt 7 around the control roller 12 greater than 20 degrees is achieved. For this purpose, the control roller 12 is arranged on the mast 3 above the winding drum 11.

The surface of the control roller 12, on which the belt 7 is wound and unwound, is crowned.

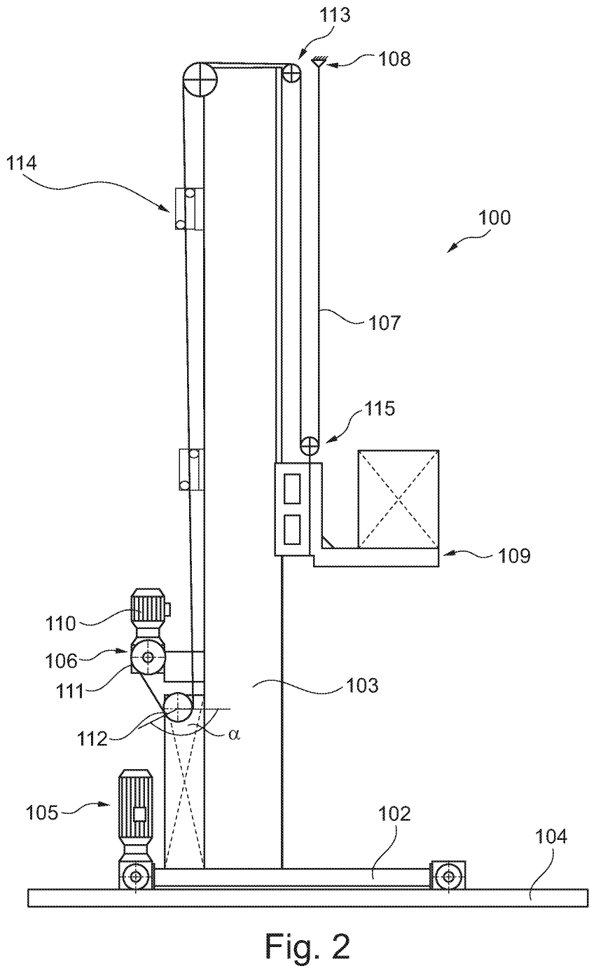

FIG. 2 illustrates an alternative embodiment 100 of the rack serving apparatus which differs essentially from the previously described embodiment in that the control roller 112 is arranged on the mast 3 below the winding drum 111 and so the angle of wrap α* of the belt 107 around the control roller 112 is greater than 20 degrees.

As a further difference, the lifting carriage 109 has a further deflecting roller 115 on the lifting carriage 109 and so in this case a 1:2 transmission is achieved.

In both variants, brackets 14, 114 for easing the run of the belt are arranged along the mast 3 and 103 respectively.

The embodiments of the invention in which an exclusive property or privilege is claimed are defined as follows:

1. A lifting device for a lifting carriage comprising:
a drive mechanism comprising a motor drive;
a winding drum driven by the motor drive; and
a belt which is unwound from and wound onto the winding drum and serves to lift and lower the lifting carriage along a mast;
wherein a control roller for targeted unwinding or winding layering of the belt on the winding drum is arranged between the winding drum and the lifting carriage such that an angle of wrap greater than 20 degrees of the belt around the control roller is achieved.

2. The lifting device as claimed in claim 1, wherein the control roller is arranged on the mast below or above relative to the winding drum.

3. The lifting device as claimed in claim 1, wherein the control roller has a crowned surface.

4. The lifting device as claimed in claim 1, wherein at least one bracket is arranged on the mast between the control roller and the lifting carriage or pulley at the mast head, in which the belt runs in a guided manner.

5. The lifting device as claimed in claim 4, wherein brackets are arranged at least every 5 meters along the mast.

6. The lifting device as claimed claim 1, wherein the belt runs via a plurality of deflectors between the control roller and the lifting carriage.

7. The lifting device as claimed in claim 6, wherein the deflectors are fastened both to the mast head or mast cross beam and to the lifting carriage.

8. The lifting device as claimed in claim 1, wherein fixed points or connection points of the belt are arranged on the lifting carriage or on the mast head or on the head cross beam depending upon the transmission ratio.

9. The lifting device as claimed in claim 1, wherein the belt is a flat belt.

10. A rack serving apparatus, wherein the rack serving apparatus comprises a lifting device as claimed in claim 1.

11. A lifting device for a lifting carriage comprising:
a drive mechanism comprising a motor drive;
a winding drum driven by the motor drive; and
a belt which is unwound from and wound onto the winding drum and serves to lift and lower the lifting carriage along a mast, wherein the belt is a flat belt;
wherein a control roller for targeted unwinding or winding layering of the belt on the winding drum is arranged between the winding drum and the lifting carriage such that an angle of wrap greater than 20 degrees of the belt around the control roller is achieved, and wherein the control roller is arranged on the mast below or above relative to the winding drum.

12. The lifting device as claimed in claim 11, wherein the control roller has a crowned surface.

13. The lifting device as claimed in claim 11, wherein at least one bracket is arranged on the mast between the control roller and the lifting carriage or pulley at the mast head, in which the belt runs in a guided manner.

13. The lifting device as claimed in claim 13, wherein brackets are arranged at least every 5 meters along the mast.

14. The lifting device as claimed claim 11, wherein the belt runs via a plurality of deflectors between the control roller and the lifting carriage.

15. The lifting device as claimed in claim 14, wherein the deflectors are fastened both to the mast head or mast cross beam and to the lifting carriage.

16. The lifting device as claimed in claim 11, wherein fixed points or connection points of the belt are arranged on the lifting carriage or on the mast head or on the head cross beam depending upon the transmission ratio.
